(19) United States
(12) Patent Application Publication
(10) Pub. No.: US 2024/0411834 A1
(43) Pub. Date: Dec. 12, 2024

(54) HARDWARE ACCELERATOR FOR SPARSE ACCUMULATION IN COLUMN-WISE SPARSE GENERAL MATRIX-MATRIX MULTIPLICTION ALGORITHMS

(71) Applicants: The Regents of the University of California, Oakland, CA (US); Lehigh University, Bethlehem, PA (US)

(72) Inventors: Chao Zhang, Bellevue, WA (US); Xiaochen Guo, Berkeley, CA (US); Maximilian Bremer, Menlo Park, CA (US); Cy Chan, San Francisco, CA (US); John Shalf, Oakland, CA (US)

(21) Appl. No.: 18/737,758

(22) Filed: Jun. 7, 2024

Related U.S. Application Data
(60) Provisional application No. 63/506,863, filed on Jun. 8, 2023.

(51) Int. Cl. G06F 17/16

(52) U.S. Cl. CPC G06F 17/16

(57) ABSTRACT

A system and method of performing sparse accumulation in column-wise sparse general matrix-matrix multiplication (SpGEMM) algorithms. The method includes receiving a request to perform SpGEMM based on a first matrix and a second matrix. The method includes accumulating, in a hardware buffer, a hash key and an intermediate multiplication result of the first matrix and the second matrix. The method includes performing a probe search of a hardware cache to identify a match between the hash key and a partial sum associated with the first matrix and the second matrix. The method includes generating, by a hardware adder, a multiplication result based on the partial sum and the intermediate multiplication result from the accumulation waiting buffer.

### CROSS-REFERENCE TO RELATED APPLICATIONS

This application claims the benefit of U.S. Provisional Application Ser. No. 63/506,863 entitled “ASA: A HARDWARE ACCELERATOR FOR SPARSE ACCUMULATION,” filed Jun. 8, 2023, the disclosure of which is incorporated herein by reference in its entirety.

### STATEMENT OF GOVERNMENT RIGHTS

This invention was made with government support under Contract No. DE-AC02-05CH11231 awarded by the U.S. Department of Energy. The government has certain rights in the invention.

### TECHNICAL FIELD

The present disclosure relates generally to electronics, and more particularly, to systems and methods of a hardware accelerator for sparse accumulation in column-wise sparse general matrix-matrix multiplication (SpGEMM) algorithms.

### BACKGROUND

Sparse linear algebra is an important kernel in many different applications. Among various SpGEMM algorithms, Gustavson's column-wise SpGEMM has good locality when reading input matrix and can be easily parallelized by distributing the computation of different columns of an output matrix to different processors. However, the sparse accumulation (SPA) operation in column-wise SpGEMM, which merges partial sums from each of the multiplications by the row indices, is still a performance bottleneck. The conventional software implementation uses a hash table for partial sum search in the SPA, which makes SPA the largest contributor to the execution time of SpGEMM.

There are three reasons that cause the SPA to become the bottleneck: 1) hash probing requires data-dependent branches that are difficult for a branch predictor to predict correctly; 2) the accumulation of partial sum is dependent on the results of the hash probing, which makes it difficult to hide the hash probing latency; and 3) hash collision requires time consuming linear search and optimizations to reduce these collisions require an accurate estimation of the number of non-zeros in each column of the output matrix.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 shows pseudocode for Algorithm 1, which is an example procedure of a column-wise SpGEMM, according to some embodiments;

FIG. 2A shows hash table sizes distribution, according to some embodiments;

FIG. 2B shows the set conflict rates of different hash table sizes and under different cache configurations, according to some embodiments;

FIG. 3 is a block diagram depicting an example an ASA architecture that uses a dedicated on-chip cache to perform sparse accumulation in column-wise SpGEMM algorithms instead of a software hash table, according to some embodiments;

FIG. 4 is a flow diagram of a procedure for using an ASA architecture, according to some embodiments;

FIG. 5 is a flow diagram of a procedure for sorting and merging key value pairs, according to some embodiments;

FIG. 6 shows a table of procedure calls, according to some embodiments;

FIG. 7 shows pseudocode for Algorithm 2, which is an example procedure of a column-wise SpGEMM using ASA architecture, according to some embodiments;

FIG. 8 is a flow diagram depicting a method of performing sparse accumulation in column-wise sparse matrix-matrix multiplication (SpGEMM), according to some embodiments; and

FIG. 9 is a block diagram of an example computing device that may perform one or more of the operations described herein, in accordance with some embodiments.

### DETAILED DESCRIPTION

Described herein is an accelerating sparse accumulation (ASA) architecture to accelerate the SPA. The ASA architecture overcomes the challenges of SPA by: 1) executing the partial sum search and accumulate with a single instruction through ISA extension to eliminate data- dependent branches in hash probing, 2) using a dedicated on-chip cache to perform the search and accumulation in a pipelined fashion, 3) relying on the parallel search capability of a set-associative cache to reduce search latency, and 4) delaying the merging of overflowed entries. As a result, the ASA architecture achieves an average of 2.25x and 5.05x speedup as compared to the conventional software implementation of a Markov clustering application and its SpGEMM kernel respectively. As compared to a conventional hashing accelerator design, the ASA architecture achieves an average of 1.95x speedup in the SpGEMM kernel.

Further, described herein are extensions to the accelerator to support masked sparse operations, which enables a broader class of sparse graph and matrix kernels, such as triangle counting, breadth-first search, and betweenness centrality.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

In an illustrative embodiment, an accelerating sparse accumulation (ASA) system includes a hardware buffer, a hardware cache, and a hardware adder. The ASA system receives an instruction to perform one or more operations associated with a sparse matrix-matrix multiplication (SpGEMM) of a first matrix and a second matrix. The ASA system accumulates, in the hardware buffer, a hash key and an intermediate multiplication result of the first matrix and the second matrix. The ASA system performs, using the hash key, a probe search of the hardware cache to identify a partial sum associated with the first matrix and the second matrix. The ASA system generates a multiplication result based on the partial sum and the intermediate multiplication result from the hardware buffer.

### 1. Introduction

Graph analytics has emerged as one of the key computational methods to solve important problems with irregular structures that arise across a variety of scientific and engineering disciplines, including bioinformatics, social networks, and physical systems. The graphs representing these problem spaces are typically large and sparse, which means that the connections among vertices are a small percentage (e.g., typically less than 1% and hyper-sparse graphs have fewer connections than the number of vertices) of the total number of vertex pairs. For example, bioinformatics applications such as metagenome assembly and protein clustering work with sparse graphs of genetic and protein sequences that have 0.35% of non-zero connections. General-purpose computer architectures that are optimized for dense computation and regular data access patterns struggle to attain high levels of computation throughput for graph analytic applications due to their innate data irregularity, which limits the capabilities to solve large and important problems in an affordable amount of time. As a result, there is a long-felt need to explore hardware acceleration for sparse graph analytic kernels.

To facilitate the optimization of these kernels in a way that can be applied across many domains, this work targets the GraphBLAS specification, which recasts graph algorithms as sparse linear algebra operations. By developing optimized designs for these primitives, the present disclosure can isolate changes to the GraphBLAS layer and use the accelerated functionality across multiple graph applications. The sparse general matrix-matrix multiplication (SpGEMM) is one of the most commonly used GraphBLAS kernels.

The present disclosure focuses on accelerating SpGEMM and assesses the performance impact of the proposed design on High-Performance Markov Clustering (HipMCL), which uses Markov clustering to identify protein families. The HipMCL algorithm consists of an iterative loop, which updates cluster membership through an expansion, pruning, and inflation phase. The expansion phase, which is represented as the local SpGEMM, is the most computationally expensive phase of the three phrases.

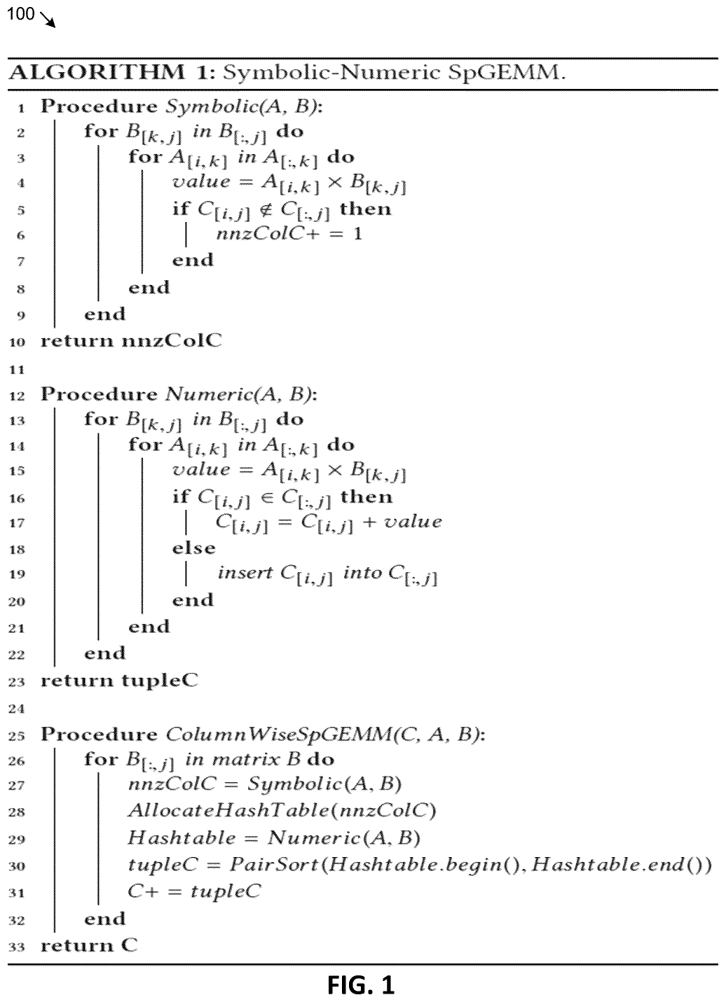

The HipMCL library adopts Gustavson's column-wise SpGEMM (referred to herein as Algorithm). For example, FIG. 1 shows pseudocode 100 for Algorithm 1, which is an example procedure of a column-wise SpGEMM, according to some embodiments. The bottleneck of Algorithm 1 is the sparse accumulation at lines 5-7 and 16-20 in Algorithm 1. Recent software implementations adopt many different data structures to do the accumulation, such as hash tables, vectorized hash tables, and heaps.

Algorithm 1 multiplies non-zeros in columns of the second input matrix B with the columns of the first input matrix A and accumulates all of the partial sums through a sparse accumulation (SPA). The conventional software implementation of the column-wise SpGEMM (e.g., Graph-BLAS) uses a hash-based SPA with a symbolic-numeric method. The symbolic phase estimates the number of non-zeros in each output column and allocates a hash table for each column. In the subsequent numeric phase, partial sums are calculated by using the row index to look up the hash table to find the latest partial sums to add to. Before writing back the output column to the memory, all of the valid entries in the hash table are sorted by their row indices. The numeric phase takes the longest latency in the local SpGEMM computation, which is dominated by the hash-based SPAs. This is because linear probing is used when there are hash collisions that map indices to the same key. Processing hash lookups on general-purpose processors also suffer from hard-to-predict branches.

Prior work has proposed HTA to accelerate common hash operations with ISA extensions. However, HTA is designed for general hash operations with a large memory footprint, whereas column-based SpGEMM can use matrix tiling to optimize for locality and to reduce hash table sizes. Using an HTA-like approach to accelerate the hashing operations in column-based SpGEMM would be overkill and cannot achieve the optimal efficiency. Moreover, accelerating hash operations alone cannot address SPA-specific computational challenges. Accelerators have been proposed for SpGEMM as well, in which hardware merger trees are used to sum up the multiplication results within a single pass. In the merger design, the radix of the merger tree should be chosen carefully to balance between latency and area. A small-radix merger has to read the same input row multiple times when the merging factor exceed the radix, whereas a large-radix merger costs a large area overhead. For example, a merge tree in SpArch costs more than 55% of the area and power.

The present disclosure proposes an ASA architecture, which is an in-core extension to a general-purpose processor for accelerating sparse accumulations in column-wise SpGEMM that maintains the generality of the multicore processors and adds minimum area overheads. There are several key features of the ASA architecture. For example, the ASA architecture extends the existing ISA to execute the partial sum search and accumulate with a single instruction, which improves the core utilization by eliminating hard-to-predict branches. The ASA architecture adds a small, dedicated set-associative on-chip cache with an accumulator to hold partial sums and compute SPAs, which improves SPA throughput and reduces dynamic energy for cache lookups. The ASA architecture replaces hash linear probing with parallel search in the set-associative cache and delays merging of partial sum entries evicted from cache due to set conflicts. The ASA architecture provides a simple software interface to allow flexible use of the ASA hardware and easy integration with other software optimization of merging and sorting.

### 2. SpGEMM Variants

SpGEMM is an important kernel in many applications, such as machine learning, numerical analysis, graph algorithms, and so on. The broad use of the SpGEMM in data-intensive applications leads to many different parallel SpGEMM implementations.

An inner product implementation computes SpGEMM using a series of dot product operations between rows of the first matrix (A) and columns of the second matrix (B) for each element of the result matrix (C):

$${C}_{[ i , j ]} = {\sum }_{k = 0}^{N - 1} {A}_{[ i , k ]} \times {B}_{[ k , j ]}$$

N is the matrix dimension, i and j are the row and column indices. Inner product SpGEMM has a good locality for matrix C and can be easily parallelized by sending different rows and columns to different cores without synchronization overhead. However, to select the non-zero elements from matrices A and B, it requires index matching before multiplication. The sparse storage format of A and B requires indirect memory accesses to load B[k, j] for each non-zero A[i, k]. These dependent loads have poor spatial locality and are on the critical path of the computation, which can cause processor stalls and low core utilization even with an ideal tiling optimization.

An outer product implementation multiplies matrix A and B by decomposing the operation into outer product multiplications of pairs of columns of A and rows of B:

$$C = {\sum }_{i = 0}^{N - 1} {C}_{i} = {\sum }_{i = 0}^{N - 1} {A}_{[ : , i ]} \times {B}_{[ i , : ]}$$

A[:, i] is the i-th column of A and B_{[i, :]} is the i-th row of B. Ci is the partial matrix of the final result matrix C. The computation is divided into two phases: (1) A[:, i]×B[i, :] multiplication and (2) partial matrix merging. For the multiplication phase, every non-zero element in A[:, i] is multiplied with every non-zero element in B[i, :]. Hence, the accesses to both matrix A and matrix B have good spatial locality and have short reuse distance. However, the partial matrix merging phase requires high synchronization overhead to merge the partial matrix products that are assigned to different cores. Other outer-product approaches, such as PB-SpGEMM, avoid the synchronization by streaming the intermediate partial matrices to memory for merging later (expand, sort, compress), which may generate substantial memory traffic.

In Gustavson's column-wise SpGEMM algorithm, columns of A are multiplied with the non-zeros of a column of B, and the results are accumulated into a column of C using a sparse accumulator (SPA).

$${C}_{[ : , j ]} = {\sum }_{k = 0}^{N - 1} {A}_{[ : , k ]} \times {B}_{[ k , j ]}$$

B[k, j] is a non-zero element in a column of matrix B,A[:, k] is the corresponding columns in matrixA, C[:, j] is a output column of matrix C. In column-wise SpGEMM, different columns can be computed in parallel.

For SpGEMM, there is no single optimal formulation for all contexts, as the performance depends on the sparsity of the input matrices as well as the compression factor. Assuming the computation of C=A×B requires nflops multiply-accumulate operations, and n_{nzc} equals the number of non-zeros in C, the compression factor is defined as n_{flops}/n_{nzc}, which corresponds to the average number of terms that must be summed up to produce a single non-zero entry of C. When the compression factor is low, the outer product formulation outperforms Gustavson's as the extra memory traffic incurred by splitting up the multiplication phase and the merging phase is relatively small. But as the compression factor rises, the lower memory traffic of Gustavson's algorithm leads it to outperform the outer product based formulation.

Ultimately, the SpGEMM implementation preference is application specific. The average compression factor of the SpGEMM and wallclock time elapsed per Markov Clustering (MCL) iteration for HipMCL on the Eukarya network with 32.4M vertices and 360M edges. Comparing the two figures, 92% of the total execution time is spent in the first five MCL iterations, which consist of high compression factor SpGEMM multiplications, which favor the use of column-wise SpGEMM algorithms. Thus, to maximize performance gains, this article focuses on optimizing the performance of column-wise SpGEMM.

In SpGEMM, the pattern and number of non-zero elements of the output matrix is unknown before computation. But the memory allocation of the output matrix should be decided ahead of time. One way is to allocate large enough memory space, which might be inefficient. The other way is to use a symbolic-numeric method (e.g., Algorithm 1 in FIG. 1) to analyze output computation patterns, which is time-consuming. Alternatively, recently developed hash-based SpGEMM algorithm uses symbolic analysis for tiling and uses hash tables within each tile to record and lookup partial sums. The purpose of symbolic analysis is to precisely control the hash table size to reduce hash probing overhead. However, the hash operations are still the performance bottleneck due to high branch mis-prediction rate and poor spatial locality. The numeric and symbolic phases dominate the execution time of the SpGEMM kernel. Therefore, in HipMCL (High-performance Markov Clustering), more than 50% of the entire application runtime is devoted to computing SpGEMM hash operations.

### 3. Motivation and Key Features of ASA Architecture

The ASA architecture is motivated by the computation challenges of the sparse accumulation in column-wise SpGEMM. The goal of this work is to overcome these challenges by designing a sparse accumulation accelerator that can be easily integrated into general-purpose multi-core architecture with minimum hardware overhead and a simple software interface. This section discusses the three key ideas of ASA to achieve this goal.

### 3.1 Extending ISA to Avoid Data-Dependent Branches

As discussed above, hash probing is the bottleneck for both symbolic and numeric phases. (See e.g., SpGEMM Variants). One reason is that the core does not know whether the probing will hit, miss, or have a collision. When multiple keys are hashed to the same cell, this cell has collisions. A hash lookup typically compares keys that are mapped to the same cell one-by-one. The implementation of hash probing requires data-dependent branches, which are difficult to predict. Prior work observed that mis-predicted branches can be the performance bottleneck of many hash-intensive applications. To avoid these difficult-to-predict branches, the ASA architecture proposes to extend an ISA with a hardware probing and accumulation (HPA) instruction similar. As a result, lines 16-20 in Algorithm 1 can be consolidated into a single instruction, which helps to reduce the total instruction count, avoid branch misprediction penalty, and improve core utilization.

The collision resolution and overflow handling are performed by hardware and are hidden from the programmer. A programming interface is included in this design to provide key- value pairs to the sparse accumulator hardware.

### 3.2 Dedicated Hardware for Probing and Accumulation

The ASA architecture adds a dedicated hardware cache to store partial sums and an accumulator per core to directly add the multiplication result to an intermediate partial sum with a matching key. The size of the cache should be small to allow fast lookup and minimize area overhead. In the symbolic-numeric method, the symbolic phase first identifies the total number of non-zeros in an output column of matrix C to allocate a hash table with an appropriate size. As a result, the software hash table size varies based on the number of non-zeros in the output column of matrix. The ASA architecture may use SUMMA, which is a distributed SpGEMM implementation, assigns each processor a submatrix of C, and broadcasts input matrices A and B to different processors that can limit the size of the output matrix sizes. As a result, with a smaller output matrix to compute, the size for each hash table can be reduced.

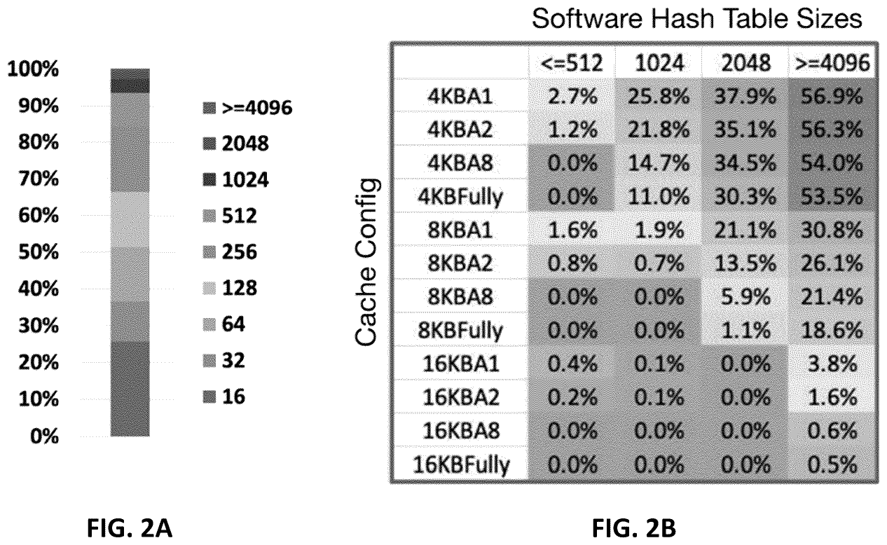

For example, FIG. 2A shows hash table sizes distribution, according to some embodiments. As shown, more than 90% of the hash tables have fewer than 512 entries, which means they can fit into a small hardware cache. Instead of storing the entries into a private L1 cache, this work uses a dedicated on-chip cache with an accumulator for sparse accumulations (Partial Sum Cache). This design choice of using a cache smaller than the L1 cache reduces the energy of cache accesses. Having a dedicated cache and an accumulator also enables high-throughput hardware probing and accumulation via pipelining the cache lookup, addition, and writeback.

Applying a tiling algorithm to the input and output matrices can help to fit the intermediate partial sums, which are stored in the hash table in the software implementation, into the partial sum cache. A set-associative cache is used to strike a balance between hardware complexity and set conflict rate. When set conflicts happen, the proposed design evicts a partial sum entry and handles these overflows later with a relatively small performance overhead. For example, FIG. 2B shows the set conflict rates of different hash table sizes and under different cache configurations, according to some embodiments. As shown, an 8-way, 8 KB cache with an 8 B block size can accommodate more than 99% of the hash probing without set conflicts, because most of the hash tables are smaller than 512.

### 3.3 Resolving Collisions in Hardware and Delaying Overflow Merging

A set-associative cache searches all of the tags (i.e., hash keys) in parallel, which is an important reason to anticipate performance improvement when comparing ASA with the software hash probing that resolves collisions through linear search. The symbolic-numeric method in GraphBLAS uses the symbolic phase to determine the hash table size to minimize collisions. It is helpful to allocate the hash table with an appropriate size for each output column, which saves space when the column is sparse and reduces collisions when the column is dense. The hardware cache has a fixed size and associativity. It is not necessary to use the symbolic phase to estimate the hash table size, but it is helpful to apply a tiling algorithm. A fallback mechanism is essential to handle cache overflows due to set conflicts.

In the ASA architecture, a FIFO queue data structure is allocated through malloc function before the sparse accumulation. Evicted entries from the partial sum cache are inserted into the FIFO queue by using a hardware address generator to issue store requests. Using dedicated hardware to handle cache overflows avoids stalling the processor. After a partial sum entry is evicted from the cache, it will not be searched for the rest of the sparse accumulation. There could be multiple intermediate partial sums in the FIFO queue that have the key, which means they need to be added together to produce the final partial sums. An architecture register is added to keep track of the size of the FIFO queue. At the end of the sparse accumulation, the head and tail pointers of the FIFO queue are read by software and these overflowed entries are merged. By taking the merging of overflowed entries off the critical path of sparse accumulation, it is also to use the partial sum cache for one column while merging overflowed entries for another column. The detailed explanation of the overflow handling with FIFO queue is in the Overflow Handling section, as discussed herein.

### 3.4 Minimizing Both Software and Hardware Overhead

Multiple SpGEMM accelerators have been proposed recently, which can be used to execute limited applications. However, serving multiple types of computational kernels in a single accelerator is challenging, because different kernels prefer different system tradeoffs. SpGEMM accelerators usually have a similar size of a CPU core. For example, SpArch uses more than 55% of the area and power for building a merge tree to accumulate partial sums. To make the design cost-effective in terms of both performance and area, the ASA architecture can provide a competitive speedup with a lightweight software interface and negligible hardware area (e.g., less than 0.1% of the core area).

### 4. ASA Architecture

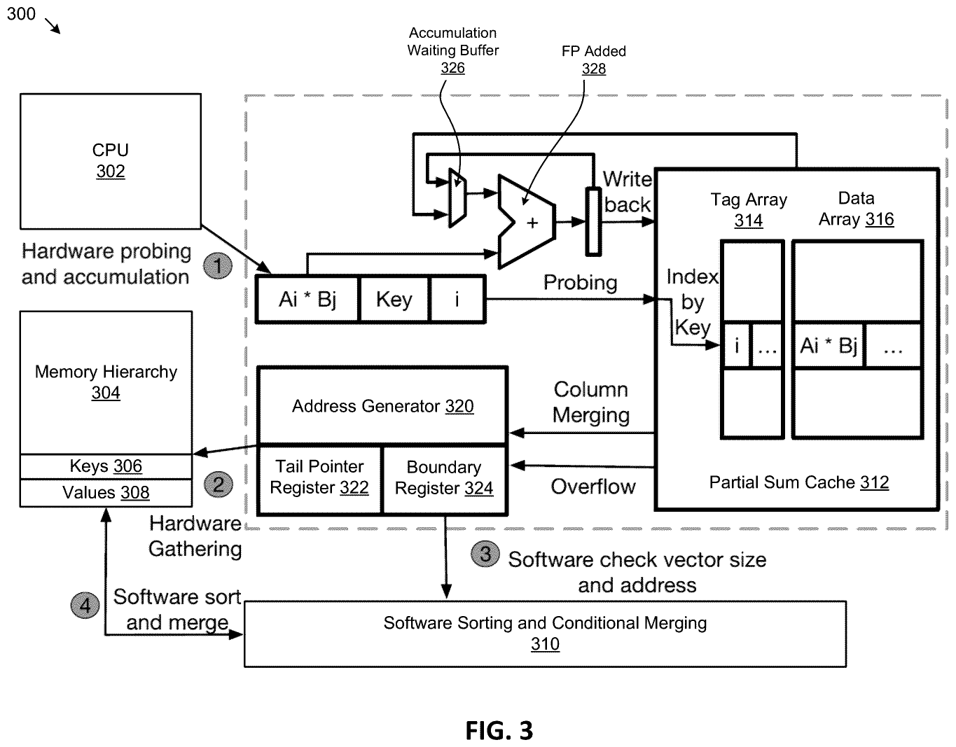

FIG. 3 is a block diagram depicting an example an ASA architecture that uses a dedicated on-chip cache to perform sparse accumulation in column-wise SpGEMM algorithms instead of a software hash table, according to some embodiments. The ASA architecture 300 augments each core with an accumulation waiting buffer 326 to store the multiplication results and its corresponding hash key, a floating-point adder 328, a partial sum cache 312 (e.g., a small hardware cache) to each core to store partial sums, and an address generator 320 for both overflow handling and hardware gathering. The address generator has two architectural registers visible to the software: a tail pointer register 322 for recording the current tail position of the associated partial sum FIFO queue in memory and a tail boundary register 324 for recording the boundary address of the allocated space. FIG. 3 shows phases 1-4.

### 4.1 Hardware Probing and Accumulation

A hardware probing and accumulation (HPA) instruction is similar to a store instruction, which has three source operands, which are the hash key for indexing cache sets, row index for tag comparison, and the multiplication result of a pair of non-zeros as the value. Similar to a store instruction an HPA instruction is issued from the load-store queue (LSQ) when the instruction is at the head of the reorder buffer and both operands are available. The hash key and the multiplication result of an issued HPA instruction will be stored in an accumulation waiting buffer to be added to a matching partial sum (phase 1 in FIG. 3). The key is used to lookup the partial sum cache by first using the key to index to the corresponding cache set and then comparing the row index i with the stored tags. If the reference hits in the cache, then the value of the matching entry is read and added with the multiplication result. If the reference misses in the cache, then a new entry is allocated and the multiplication result is directly stored in the cache. If miss in the cache but the corresponding cache set is full, then a cache overflow happens. An entry needs to be selected according to a replacement policy and evicted from the cache. A good choice of the replacement policy will help to prevent premature evictions. This work uses a least recently used (LRU) replacement policy.

Each HPA instruction takes three cycles to complete after being issued from the LSQ. One cycle for cache lookup, one cycle for accumulation, and another cycle for writing back to cache. To improve the throughput, a three-stage pipeline is implemented such that when one HPA instruction is computing accumulation, the following HPA issued back-to-back can lookup the cache. It is possible that the back-to-back HPAs have matching keys, hence the hash key also needs to compare with the keys of the previous outstanding HPAs. If the back-to-back HPAs have the same key, then the previous accumulation result is forwarded to the input of the accumulator.

### 4.2 Overflow Handling

A contiguous memory address space is pre-allocated to store both the overflowed key-value pairs of the partial sum entries evicted from the partial sum cache during the hardware probing and accumulation phase (phase 1 in FIG. 3) as well as the writeback partial sum entries during the hardware gathering phase (phase 2 in FIG. 3). The memory space pre-allocation is done in software in a FIFO queue data structure. During phases 1 and 2, the FIFO requires only insertion operations. An address generator is added to the ASA architecture 300 to calculate the virtual addresses for these insertions to the FIFO queue, which is equipped with a tail pointer register 322 storing the position of the next insertion and a tail boundary register 324 storing the boundary address of the pre-allocated memory space. The virtual address range is sent to the ASA architecture 300 when the memory space for the FIFO queue is pre-allocated. The tail pointer register 322 is initialized to the start position (e.g., head pointer) of the pre-allocated FIFO queue.

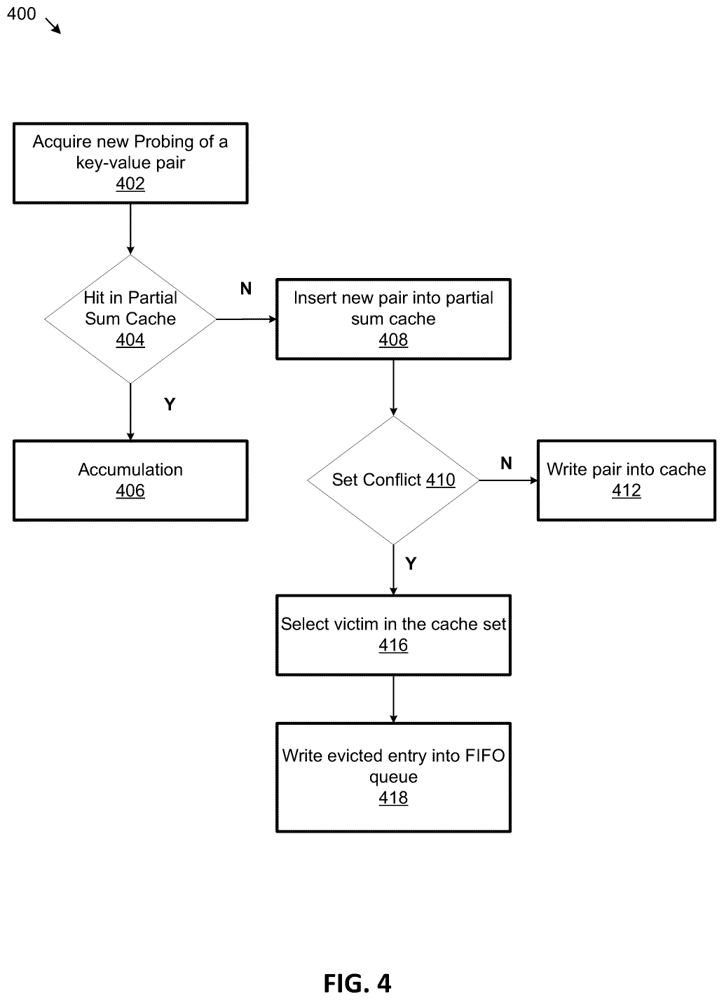

Each eviction of the key-value pair will use the tail pointer value to calculate the addresses for the key and the value. For example, FIG. 4 is a flow diagram of a procedure for using an ASA architecture, according to some embodiments. Although the operations are depicted in FIG. 4 as integral operations in a particular order for purposes of illustration, in other implementations, one or more operations, or portions thereof, are performed in a different order, or overlapping in time, in series or parallel, or are omitted, or one or more additional operations are added, or the method is changed in some combination of ways. In some embodiments, the procedure 400 may be performed by processing logic that includes hardware (e.g., circuitry, dedicated logic, programmable logic, microcode, etc.), firmware, or a combination thereof. In some embodiments, some or all operations of procedure 400 may be performed by one or more components (e.g., CPU 302, memory hierarchy 304, address generator 320, partial sum cache) of the ASA architecture in FIG. 3.

At operation 402, in some embodiments, the ASA architecture 300 acquires new probing of a key-value pair 402. At operation 404, in some embodiments, the ASA architecture 300 determines whether there is a partial sum cache. If there is a hit in the partial sum cache 312, then the ASA architecture 300 proceeds to operation 406 to perform accumulation. However, if there is no hit in the partial sum cache 312, then the ASA architecture 300 proceeds to operation 408 to insert a new pair into the partial sum cache 312.

At operation 410, in some embodiments, the ASA architecture 300 determines whether there is a set conflict. If there is not a set conflict, then the ASA architecture 300 proceeds to operation 412 to write pair into the partial sum cache 312. However, if there is hit in the partial sum cache 312, then the ASA architecture 300 proceeds to operation 416 to select victim in the cache set. At operation, in some embodiments, the ASA architecture 300 writes evicted entry into the FIFO queue.

Referring back to FIG. 3, the ASA architecture 300 generates normal store instructions to write these entries into the FIFO queue through the memory hierarchy, which is the same as other store instructions from the load store queue. An evicted partial sum entry due to cache overflow can have a repeating key with another evicted entry or the same key as a writeback entry. To prevent stalling, the hardware overflow handling does not merge these entries with repeating keys at the eviction time. After each insertion to the FIFO queue, the tail pointer will increment and compare with the value of the tail boundary register 324. If the tail pointer equals to or exceeds the boundary address, then the FIFO queue is full and an interrupt is triggered to allocate more space. After memory allocation, both the tail pointer and the tail boundary registers 324 are reset accordingly for the newly allocated space.

### 4.3 Sorting and Merging

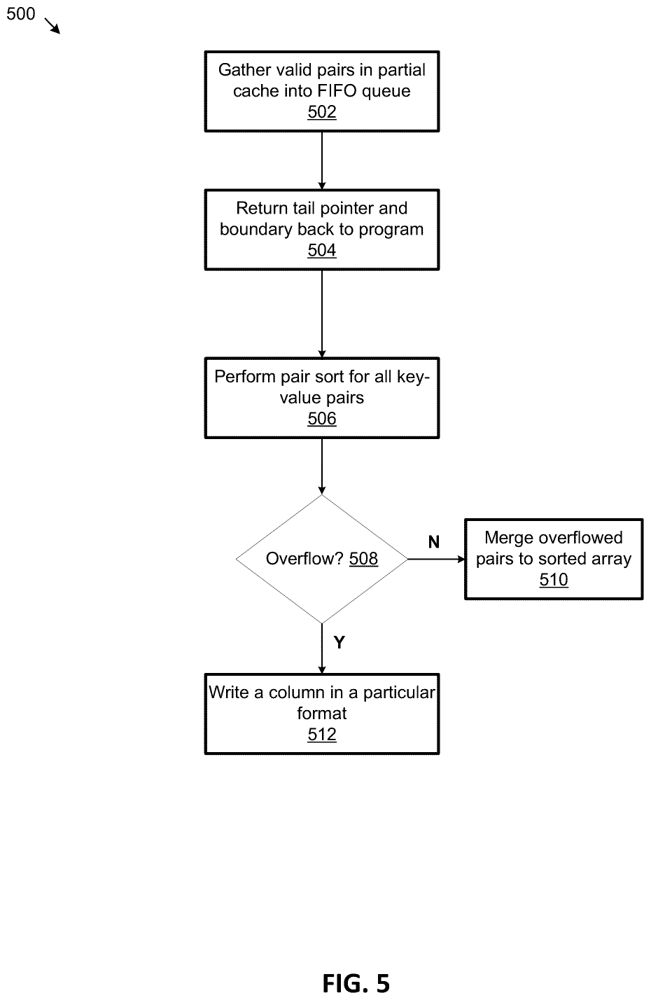

FIG. 5 is a flow diagram of a procedure for sorting and merging key value pairs, according to some embodiments. Although the operations are depicted in FIG. 5 as integral operations in a particular order for purposes of illustration, in other implementations, one or more operations, or portions thereof, are performed in a different order, or overlapping in time, in series or parallel, or are omitted, or one or more additional operations are added, or the method is changed in some combination of ways. In some embodiments, the procedure 500 may be performed by processing logic that includes hardware (e.g., circuitry, dedicated logic, programmable logic, microcode, etc.), firmware, or a combination thereof. In some embodiments, some or all operations of procedure 500 may be performed by one or more components (e.g., CPU 302, memory hierarchy 304, address generator 320, partial sum cache) of the ASA architecture in FIG. 3.

At operation 502, in some embodiments, the ASA architecture 300 gathers valid pairs in partial cache into FIFO queue. At operation 504, in some embodiments, the ASA architecture 300 returns tail pointer and boundary back to the program. At operation 506, in some embodiments, the ASA architecture 300 performs a pair sort for all key-value pairs. At operation 508, in some embodiments, the ASA architecture 300 determines whether there is an overflow. If there is no overflow, then the ASA architecture 300 proceeds to operation 510 to merge overflowed pairs to a sorted array. However, if there is an overflow, then the ASA architecture 300 proceeds to operation 512 to write a column in a particular format (e.g., Double-Compressed Sparse Column or Row (DCSC format))

Thus, as shown in FIG. 5, all valid entries in the partial sum cache are first added to the FIFO queue, which waits for a subsequent sorting operation. Implementing sorting logic in the hardware can be expensive, whereas the execution time of sorting non-zeros of the output column in software is relatively low for SpGEMM as compared to other operations. Hence, this design keeps sorting in software. After the gathering phase 2, all key-value pairs are written into FIFO queue in memory. A pair sort is used to sort all key-value pairs by its keys, which is the same as the original software implementation. The pair sort needs the start and end position of the unsorted FIFO queue. In phase 3, the software reads the tail pointer register value before and after the hardware gathering. The sorted tupleC can be directly added to the output matrix C if there are no overflows during the column computation (phase 4). If there are overflowed key-value pairs, then additional merge operations can be performed to add the overflowed entries to the sorted array. In this case, entries with the same key would be merged first. After that, all key-value pairs would be sorted to the output tupleC, which takes additional O(N) of time complexity on top of the original software sorting with O(NlgN).

Overflow requires additional instructions, which can offset the benefits of using the proposed partial sum cache. The amount of the overflows can be well controlled if appropriate tiling algorithm is applied to the column-wise SpGEMM. This means breaking down the denser columns of the input matrix B into multiple smaller sub-columns.

### 4.4 Context Switch

Modern processors usually adopt Lazy FP State Save/Restore, which defers the save and restore of certain CPU context states on the task switch. Similarly, the content in the partial sum cache is part of the state that will be saved and restored lazily when the hardware resources are not required in a new context.

### 5. Programming Interface for the ASA architecture

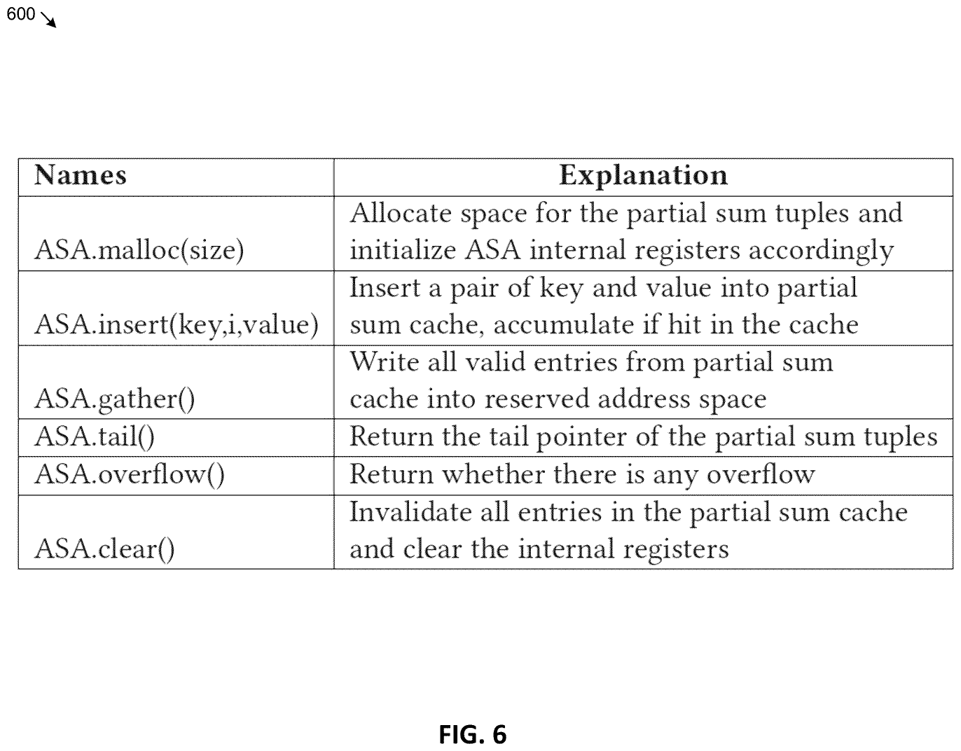

The ASA architecture includes a simple programming interface to use ASA. For example, FIG. 6 shows a table of procedure calls according to some embodiments.

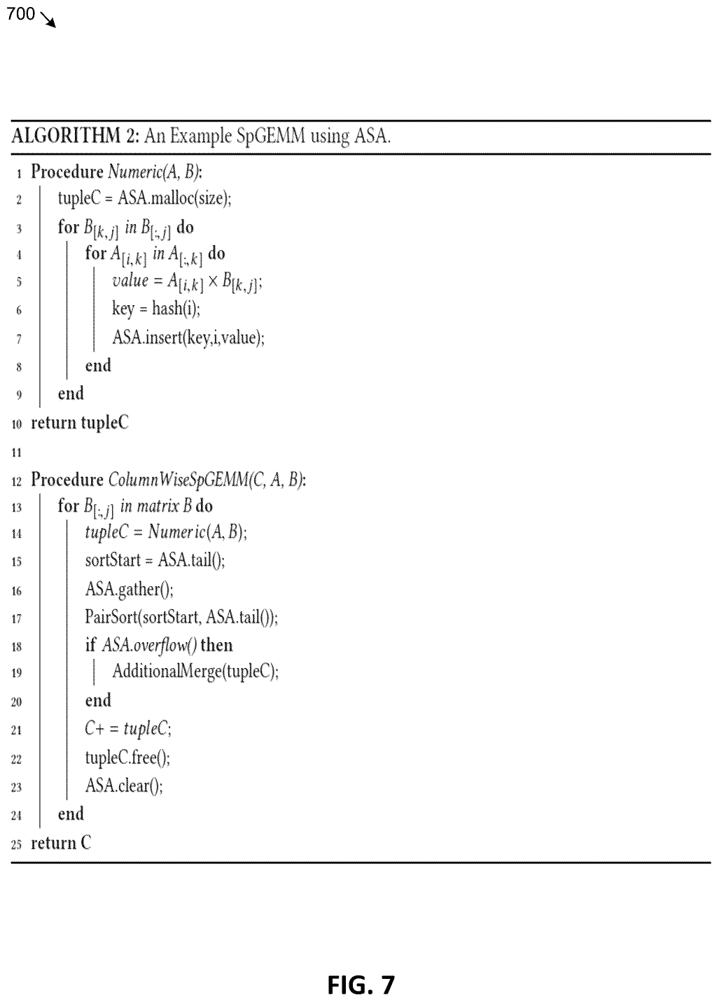

FIG. 7 shows pseudocode for Algorithm 2, which is an example procedure of a column-wise SpGEMM using ASA architecture, according to some embodiments. Compressed data format (e.g., DCSC [9]) is typically used for both the input and output matrices to reduce memory footprint by avoiding storing zeros. During the computation of each output column, the partial sums can be calculated in an order different from the index order. Hence, a series of key-value pairs are stored in a FIFO queue data structure (e.g., tupleC in Algorithm 2), where the key is the row index and the value is the partial sum. This FIFO queue is used when storing the intermediate partial sums as well as the final sorted non-zeros of an output column. The size of the memory allocation (e.g., line 2 in Algorithm 2) should be equal to or greater than the capacity of the partial sum cache. If more cache overflows are anticipated, then a larger size can be pre-allocated. This parameter can be optimized for different matrices and partitions.

As discussed above, the symbolic phase can be removed when using the ASA architecture 300. In the numeric phase, the proposed design uses the FPU in the core for multiplication of A[i,k] and B[k, j].

The present embodiments describe the design choice of not offloading the multiplication and hash key calculation. (See e.g., Motivation and Key Features of ASA Architecture). Lines 16-20 in Algorithm 1 now can be replaced with a simpler ASA.insert (key, i, value) function at line 7 in Algorithm 2. The key is the hash value calculated by applying the hash function to the original row index i for A[i,k], which achieves better load balancing among cache sets than row indices does when used to index the hardware cache. ASA.insert (key, i,value) will insert a pair of key and value to the partial sum cache (e.g., dedicated for sparse accumulation). If the key hits in the cache, then it reads the current partial sum C[i, j], adds value with C[i, j], and stores the new partial sum back to the cache. The cache lookup, addition, and writeback are perceived as an atomic operation. If the key misses in the cache, then it inserts a new entry into the cache. Cache overflow is handled by hardware. (See e.g., Overflow Handling section). The evicted entries will be stored in the pre-allocated tupleC. Regardless of partial sum cache hit, miss, or overflow, the ASA unit will handle it by hardware without data-dependent branches, which is one of the key advantages as compared to the original software implementation.

After the numeric phase, ASA.gather() (e.g., line 16) writes all of the valid entries into tupleC following evicted partial sums if there are cache overflows during the numeric phase. The tail pointer position is recorded before calling ASA.gather() to allow a pair sort function call to perform in place sorting on non-repeating keys (e.g., line 17). If there are overflows for this column computation, then additional software merges to tupleC will be used to merge overflowed key-value pairs to the sorted key-value pairs in tupleC (e.g., lines 18-20) with O(N) time complexity, where N is the total number of the overflows. After this additional merging, the size of tupleC might be reduced and can be added to matrix C in the compressed storage format. Finally, the allocated space for tupleC is released and ASA.clear() (e.g., line 23) is invoked to clear the partial sum cache and ASA internal registers.

### 6. Evaluation Results of ASA Architecture

This section presents the evaluation results of the proposed ASA architecture on performance and energy. A roofline model analysis is performed to demonstrate the computation bottlenecks. Moreover, sensitivity studies are conducted on the partial sum cache configurations and alternative design choices on offloading computation to the hardware accelerator.

### 6.1 Benefits over Conventional SpGEMM Systems

The performance benefit of the ASA architecture 300 in FIG. 3 comes from three aspects: (1) it avoids branch mis-prediction penalty in the baseline hash-based SpGEMM, (2) it reduces the total number of the instructions by consolidating hash probing, collision handling, and accumulation operations into a single instruction and removing symbolic phase, and (3) it provides a higher throughput for sparse accumulation by using a dedicated cache and accumulator.

Speedup: On average, the ASA architecture 300 achieves a 2.25x speedup as compared to the baseline hash-based SpGEMM, which is 67% more than what HTA can achieve. As compared to HTA, which accelerates only hash operations, the ASA architecture 300 uses a dedicated partial sum cache and a dedicated accumulator to provide higher throughput for sparse accumulation. HTA relies on a software rollback for collision and overflow handling. Overflows in the HTA table will trigger a software fallback path for an update, whereas the ASA architecture 300 uses the address generator to write the overflowed entries to a pre-allocated memory space and merge overflowed partial sums in the end. HTA evicts a randomly chosen key-value pair to the next level to make space for a new one, which may cause premature eviction when hash probing has locality. The ASA architecture 300 uses a Least Recently Used (LRU) replacement policy to exploit locality in SpGEMM computation and minimize premature eviction of partial sums. HTA was designed for hash-intensive applications, especially those that have large hash tables, where poor locality causes cache thrashing and long memory stalls. In SpGEMM, the input matrices can be partitioned into tiles to allow non-zeros in a sub-column to fit into on-chip caches; the sparse accumulation throughput is a greater concern than cache thrashing. In fact, applying tiling does not help to improve performance for the baseline nor the HTA for the evaluated application and inputs. This is because the non-zeros in each output column can already fit in an L1 cache. Tiling does not provide more locality benefit for the baseline and HTA, but rather adds overheads due to increased number of branches and more irregular memory accesses in the tiled input matrix A.

In contrast, tiling helps to improve performance for the ASA architecture 300 by reducing cache overflows in the small partial sum cache. That is, input graphs that observe a large reduction on cache overflows (e.g., pb, subgraph4, subgraph5, Eukarya, and archaea) have performance benefit from tiling.

Speedup breakdown: The ASA architecture 300 helps to improve hash probing throughput and increase the amount of overhead that comes from the cache overflows. That is, on average, the ASA architecture 300 can achieve a 4.55x of performance speedup for the SpGEMM kernel. The symbolic phase takes 14.5% of the execution time for the baseline, which can be eliminated from ASA-enabled SpGEMM. The sparse accumulation (the hash-based numeric phase) takes 76% of the baseline runtime, which can be reduced by up to 6.33 times. The performance overhead of the ASA architecture 300 is when there are overflows and costs conditional merging for all of the overflowed entries. In the baseline SpGEMM, sorting and merging takes 8.7% of the total execution time, whereas in the ASA architecture 300, sorting and merging now takes 9.5% relative to the baseline execution time. As a result, the conditional merging only costs 0.8% of the total performance overhead, because the selected partial sum cache allows most of the hash probing to be overflow-free. Applying tiling can further reduce the number of overflows and hence reduce the sorting and merging latency to 8.45% of total execution time. This is because sorting multiple small chunks takes less time than sorting all chunks together.

Furthermore, the overall performance of the MCL algorithm can be improved by 2.25x because of the speedup from the SpGEMM kernel.

### 6.2 Offload Hash and Multiplication

The ASA architecture 300 does not offload hash key calculation and multiplication to hardware for a cost-effective design. Adding more hardware resources for hash key calculation and multiplication (e.g., lines 5-6 in Algorithm 2) can further achieve an average of 15.8% and a 5.3% of additional speedup for the SpGEMM kernel and the HipMCL application, respectively.

There are three reasons to keep hash key computation and multiplication in software: (1) the programmer can have the flexibility to explore different hash functions, which may result in different optimal choices for different problem domains. The choice of the hash function will influence the load balancing among different cache sets, which can result in different number of cache overflows due to set conflicts. The evaluated design uses a prime number modulo hash function. (2) Multiplications of the non-zero elements can be vectorized using an existing vector engine inside the core to achieve higher throughput such as the Intel AVX-512. The evaluated design of ASA uses the existing floating-point unit (FPU) to reduce area overhead. And (3) offloading hash function and multiplication to dedicated hardware logic only achieves an incremental improvement according to the simulation results of the selected inputs.

### 6.3 Overflow Rate

Instead of precisely split tiles based on the number of nonzeros, the present embodiments use a simple tiling algorithm that breaks dense output columns into multiple sub-columns. During the actual computation, if a column of C will cause overflow, then the column is broken up into several chunks. The chunks span uniform parts of A, e.g., if A has 2 million rows and the ASA architecture 300 intends to break the column into 2 chunks, then the first chunk will contain entries [0,1e6) and the second chunk [1e6,2e6). The ASA architecture 300 may assume that the distribution of the non-zeros is not particularly skewed towards either chunk. The SpGEMM then proceeds to fully compute one chunk at a time. The overflow rate can be significantly reduced by applying a simple tiling algorithm.

### 6.4 Partial Sum Cache Configurations

The size and associativity of the partial sum cache can influence the set conflict rate, as shown in FIG. 4B. Also, the performance is more sensitive to the cache capacity than associativity. In the present embodiments, the partial sum cache is implemented as a fine-grained cache with a block size equal to the word size of a partial sum (e.g., 8 B). The ASA architecture 300 can achieve a good speed up with a 4 KB cache, which can save up to 512 key-value pairs. The tiling algorithm selects the size of the sub-matrices to fit the number of non-zeros into the cache. The smaller the cache, the faster the cache lookup and the lower the lookup energy. However, if the cache is too small, then the input sub-matrices of A would have fewer rows and hence increase the amount of irregular accesses due to the DCSC storage format used in HipMCL. Ideally, in some embodiments, the partial sum cache is large enough to allow the input data broadcasting to saturate the system memory bandwidth, yet small enough to allow fast cache lookup to match with the demand sparse accumulation throughput. This optimal design point of cache size depends on the sparsity and merging factor of the matrices.

### 6.5 Roofline Modeling

Sparse accumulation is the bottleneck of the baseline system that prevents it from achieving a higher throughput. A roofline model for HipMCL application with different inputs may include bandwidth ceilings of different levels of the memory hierarchy and a computation ceiling. The original HipMCL implementation does not fully utilize the memory bandwidth nor the processing throughput. This is because the sparse accumulation is bounded by the data-dependent branches. The ASA architecture 300 eliminates those hard-to-predict branches and improves sparse accumulate throughput using dedicated partial sum caches. The performance is improved by more than 2 times. As a result, for all of the inputs, their positions on the roofline graph are shifted toward the upper left. After using the ASA architecture 300, all of the inputs are closer to the rooflines. Most inputs are bounded by the memory and last level cache throughput.

### 6.6 Instruction Reduction

The proposed ASA reduces the total number of instructions by (1) packing complicated hash probing and collision handling into a single instruction and (2) removing the symbolic execution, as the implementation does not require allocating the hash table from software anymore. On average, the HipMCL algorithm running on ASA architecture observes a 54.4% dynamic instruction reduction as compared to the baseline. Although additional instructions are expected when there are cache overflows, the frequency of overflows remains low for all evaluated inputs. As a result, it does not contribute a large portion to the total instruction count.

### 6.7 On-chip Energy

HTA reduces the energy consumption and achieves a better performance as compared to the baseline. The ASA architecture 300 reduces more energy as compared to HTA. There are three reasons for this further energy reduction. (1) The reduced instruction counts contribute to a reduction in energy associated with instruction fetching and decoding. (2) hardware hash probings in ASA use a smaller partial sum cache, which has a lower access energy than the access energy of an L1 cache. And (3) the reduced execution time in ASA reduces energy associated with leakage power. As a result, the ASA reduces the total on-chip energy by 57.1% as compared to the baseline, which is a nearly 20% more reduction than HTA does.

### 6.8 Execution Time-Breakdown

The ASA architecture 300 can reduce the stalling by branch mispredictions more than HTA does. This is because the ASA architecture 300 can handle collision and data-dependent accumulation automatically by hardware. Moreover, the ASA architecture 300 offloads the sparse accumulation to the partial sum cache. Execution time on L1 and LLC cache is also significantly reduced as compared to baseline.

### 6.9 Area Overhead

The area overhead of the ASA architecture 300 includes four major components: (1) the partial sum caches, (2) the additional FP adders, (3) the accumulation waiting buffers, and (4) the address generators. The total area overhead is 0.014 mm2 at 14 nm, which occupies 0.013% of an 8-core processor die (100.708 mm2).

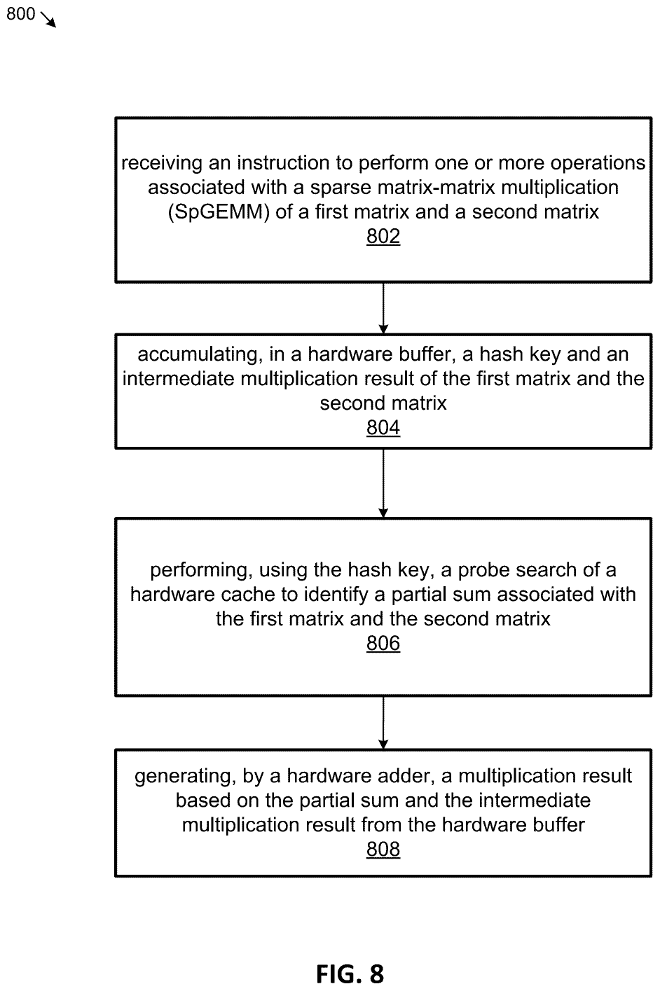

FIG. 8 is a flow diagram depicting a method of performing sparse accumulation in column-wise sparse matrix-matrix multiplication (SpGEMM), according to some embodiments. Method 800 may be performed by processing logic that may include hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. In some embodiments, method 800 may be performed by an ASA architecture, such as ASA architecture 300 in FIG. 3.

With reference to FIG. 8, method 800 illustrates example functions used by various embodiments. Although specific function blocks (“blocks”) are disclosed in method 800, such blocks are examples. That is, embodiments are well suited to performing various other blocks or variations of the blocks recited in method 800. It is appreciated that the blocks in method 800 may be performed in an order different than presented, and that not all of the blocks in method 800 may be performed.

As shown in FIG. 8, the method 800 includes the block 802 of receiving an instruction to perform one or more operations associated with a sparse matrix-matrix multiplication (SpGEMM) of a first matrix and a second matrix. The method 800 includes the block 804 of accumulating, in a hardware buffer, a hash key and an intermediate multiplication result of the first matrix and the second matrix. The method 800 includes the block 806 of performing, using the hash key, a probe search of a hardware cache to identify a partial sum associated with the first matrix and the second matrix. In some embodiments, performing the probe search of the hardware cache is further performed without accessing partial sums from at least one of a software data structure or a cache of a processing device to improve a probe search latency associated with performing the probe search. The method 800 includes the block 808 of generating, by a hardware adder, a multiplication result based on the partial sum and the intermediate multiplication result from the hardware buffer.

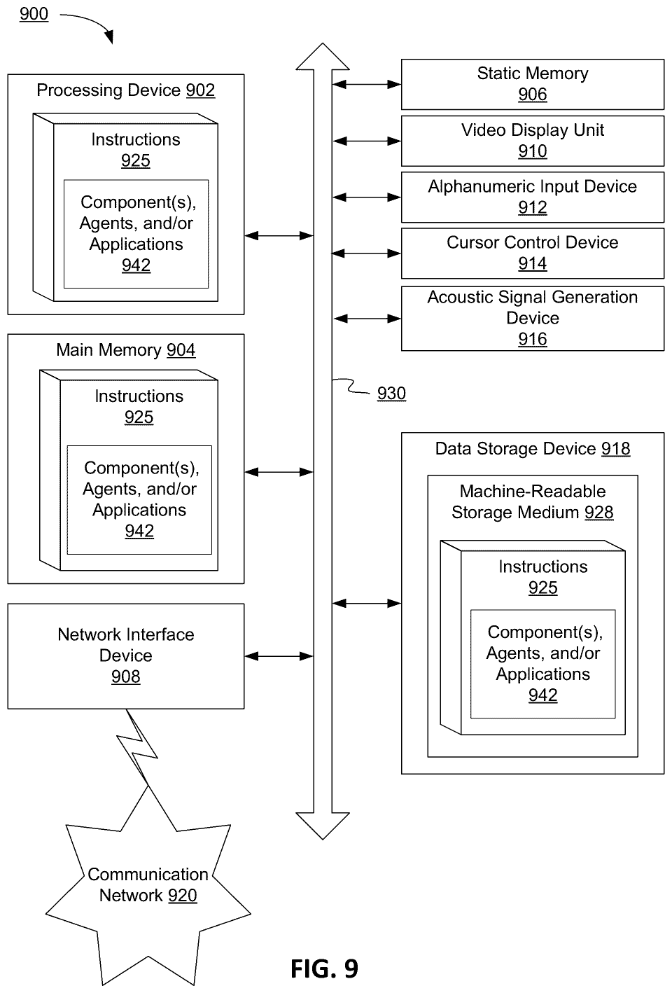

FIG. 9 is a block diagram of an example computing device that may perform one or more of the operations described herein, in accordance with some embodiments. Computing device 900 may be connected to other computing devices in a LAN, an intranet, an extranet, and/or the Internet. The computing device 900 may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 900 may include a processing device (e.g., a general-purpose processor, a PLD, etc.) 902, a main memory 904 (e.g., synchronous dynamic random-access memory (DRAM), read-only memory (ROM)), a static memory 906 (e.g., flash memory and a data storage device 918), which may communicate with each other via a bus 930.

Processing device 902 may be provided by one or more general-purpose processing devices such as a microprocessor, central processing unit, or the like. In an illustrative example, processing device 902 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 902 may also include one or more special-purpose processing devices such as an application specific integrated circuit (ASIC), a field programmable gate array (FPGA), a digital signal processor (DSP), network processor, or the like. The processing device 902 may be configured to execute the operations described herein, in accordance with one or more aspects of the present disclosure, for performing the operations and steps discussed herein.

Computing device 900 may further include a network interface device 908 which may communicate with a communication network 920. The computing device 900 also may include a video display unit 910 (e.g., a liquid crystal display (LCD) or a cathode ray tube (CRT)), an alphanumeric input device 912 (e.g., a keyboard), a cursor control device 914 (e.g., a mouse) and an acoustic signal generation device 916 (e.g., a speaker). In one embodiment, video display unit 910, alphanumeric input device 912, and cursor control device 914 may be combined into a single component or device (e.g., an LCD touch screen).

Data storage device 918 may include a computer-readable storage medium 928 on which may be stored one or more sets of instructions 925 that may include instructions for one or more components, agents, and/or applications 942 for carrying out the operations described herein, in accordance with one or more aspects of the present disclosure. Instructions 925 may also reside, completely or at least partially, within main memory 904 and/or within processing device 902 during execution thereof by computing device 900, main memory 904 and processing device 902 also constituting computer-readable media. The instructions 925 may further be transmitted or received over a communication network 920 via network interface device 908.

While computer-readable storage medium 928 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “accumulating,” “performing,” “generating,” “acquiring,” “selecting,” “configurating,” determining, “inserting,” “storing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
receiving an instruction to perform one or more operations associated with a sparse matrix-matrix multiplication (SpGEMM) of a first matrix and a second matrix;
accumulating, in a hardware buffer, a hash key and an intermediate multiplication result of the first matrix and the second matrix;
performing, using the hash key, a probe search of a hardware cache to identify a partial sum associated with the first matrix and the second matrix; and
generating, by a hardware adder, a multiplication result based on the partial sum and the intermediate multiplication result from the hardware buffer.

2. The method of claim 1, further comprising:
acquiring a dataset indicative of a plurality of conflict rates for a plurality of hardware cache capacities;
selecting a particular hardware cache capacity from the plurality of hardware cache capacities based on a particular conflict rate of the particular hardware cache capacity and at least one of a probe search latency, an energy efficiency, or a cache associativity; and
configuring the hardware cache based on the particular hardware cache capacity.

3. The method of claim 1, wherein performing the probe search of the hardware cache is further performed without accessing partial sums from at least one of a software data structure or a cache of a processing device to improve a probe search latency associated with performing the probe search.

4. The method of claim 1, further comprising:
performing a plurality of probe searches of the hardware cache for a plurality of hash keys using a parallel search procedure instead of a linear search procedure.

5. The method of claim 1, further comprising:
storing a plurality of hash keys and a plurality of partial sums in the hardware cache.

6. The method of claim 1, further comprising:
accumulating, in the hardware buffer, a second hash key and a second intermediate multiplication result of the first matrix and the second matrix;
determining an absence of the second hash key in the hardware cache; and
storing the second hash key and the second intermediate multiplication result in the hardware cache responsive to determining the absence of the second hash key in the hardware cache.

7. The method of claim 1, further comprising:
performing, using a second hash key, a second probe search of the hardware cache;
detecting a conflict event responsive to performing the second probe search of the hardware cache; and
evicting, from the hardware cache, a second partial sum associated with the second hash key.

8. The method of claim 7, further comprising:
generating, using an address generator, a virtual address for one or more insertions into a FIFO queue data structure; and
inserting the second partial sum into the FIFO queue data structure based on the virtual address.

9. The method of claim 8, wherein inserting the second partial sum into the FIFO queue data structure based on the virtual address further comprises:
generating, by a tail pointer hardware register, a next insertion address of the FIFO queue data structure; and
generating, using a tail boundary hardware register, a boundary address of the FIFO queue data structure.

10. The method of claim 1, further comprising:
receiving, via a programming interface, a plurality of key-value pairs; and
selecting the hash key from the plurality of key-value pairs.

11. An accelerating sparse accumulation (ASA) system comprising:
a hardware buffer to:
receive an instruction to perform one or more operations associated with a sparse matrix-matrix multiplication (SpGEMM) of a first matrix and a second matrix; and
accumulate a hash key and an intermediate multiplication result of the first matrix and the second matrix;
a hardware cache coupled to the hardware buffer, the hardware cache to perform, using the hash key, a probe search of the hardware cache to identify a partial sum associated with the first matrix and the second matrix; and
a hardware adder coupled to the hardware cache, the hardware adder to generate a multiplication result based on the partial sum and the intermediate multiplication result from the hardware buffer.

12. The ASA system of claim 11, wherein to perform the probe search of the hardware cache is further performed without accessing partial sums from at least one of a software data structure or a cache of a processing device to improve a probe search latency associated with performing the probe search.

13. The ASA system of claim 11, wherein the hardware cache is further to:
perform a plurality of probe searches of the hardware cache for a plurality of hash keys using a parallel search procedure instead of a linear search procedure.

14. The ASA system of claim 11, wherein the hardware cache is further to:
store a plurality of hash keys and a plurality of partial sums.

15. The ASA system of claim 11, wherein the hardware cache is further to:
accumulate a second hash key and a second intermediate multiplication result of the first matrix and the second matrix;
determine an absence of the second hash key in the hardware cache; and
store the second hash key and the second intermediate multiplication result responsive to determining the absence of the second hash key.

16. The ASA system of claim 11, wherein the hardware cache is further to:
perform, using a second hash key, a second probe search of the hardware cache;
detect a conflict event responsive to performing the second probe search of the hardware cache; and
evict, from the hardware cache, a second partial sum associated with the second hash key.

17. The ASA system of claim 16, further comprising:
an address generator coupled to the hardware cache, the address generator to:
generate a virtual address for one or more insertions into a FIFO queue data structure; and
insert the second partial sum into the FIFO queue data structure based on the virtual address.

18. The ASA system of claim 17, further comprising:
a plurality of registers coupled to the address generator, the plurality of registers to:
generate a next insertion address of the FIFO queue data structure; and
generate a boundary address of the FIFO queue data structure.

19. The ASA system of claim 11, further comprising:
a programming interface to receive a plurality of key-value pairs comprising the hash key.

20. An integrated circuit (IC) device comprising:
a hardware buffer to accumulate a hash key and an intermediate multiplication result of a first matrix and a second matrix, the intermediate multiplication result generated based on a sparse matrix-matrix multiplication (SpGEMM);
a hardware cache coupled to the hardware buffer, the hardware cache to:
store a plurality of hash keys and a plurality of partial sums; and
perform, using the hash key, a probe search of the hardware cache to identify a partial sum associated with the first matrix and the second matrix; and
a hardware adder coupled to the hardware cache, the hardware adder to generate a multiplication result based on the partial sum and the intermediate multiplication result from the hardware buffer.
